(19) United States
(12) Patent Application Publication
(10) Pub. No.: US 2015/0035648 A1
(43) Pub. Date: Feb. 5, 2015

(54) METHOD AND APPARATUS FOR ENSURING THE USE OF GENUINE CONSUMABLE OR REPLACEMENT PARTS

(71) Applicant: John Temple, Chelsea, MI (US)

(72) Inventor: John Temple, Chelsea, MI (US)

(21) Appl. No.: 14/445,363

(22) Filed: Jul. 29, 2014

Related U.S. Application Data
(60) Provisional application No. 61/859,978, filed on Jul. 30, 2013.

(51) Int. Cl. G06K 19/10

(52) U.S. Cl. CPC G06K 19/10
USPC 340/5.86

(57) ABSTRACT

Apparatus and methods ensure that only genuine, licensed or authorized parts are used with a system. The apparatus comprises visual indicia on or in the part confirming that the part is genuine, licensed or authorized. A scanner or camera on or in the system reads the visual indicia, and a controller in communication with the scanner or camera is operative to reduce the functionality of the system if the visual indicia is incomplete or not present. In accordance with the embodiment, the system may not operate if the visual indicia is incomplete or not present. The visual indicia may include a trademark, logo, or other information proprietary to a source of origin. The system may be a piece of medical equipment, and the part may be a consumable. As examples, the system may be a medical insufflators, and the part may be an insufflation set.

### REFERENCE TO RELATED APPLICATION

This application claims priority from U.S. Provisional Patent Application Ser. No. 61/859,978, filed Jul. 30, 2013, the entire content of which is incorporated herein by reference.

### FIELD OF THE INVENTION

This invention relates generally to equipment and instrumentation and, in particular, to apparatus and methods for ensuring that genuine consumable components are used with such devices.

### BACKGROUND OF THE INVENTION

In many industries, companies design machines and/or instruments that require auxiliary devices during operation. For an example, an arc welder uses cable; medical insufflators use tubing sets, IV pumps and controllers, automotive vehicles may require body parts, windshields, and tires; and so forth.

A significant problem, particularly in the medical device area, is that many substandard parts are released into the market by competing companies that only manufacture the auxiliary device(s). Replacement parts or consumable components provided by non-OEMs (original equipment manufacturers) may not fit properly, or may cause the equipment for which they are supplied to malfunction or not work at all, particularly if lower in quality than genuine replacement parts.

### SUMMARY OF THE INVENTION

This invention is directed to apparatus and methods for ensuring that only genuine, licensed or authorized parts are used with a system. The apparatus comprises visual indicia on or in the part confirming that the part is genuine, licensed or authorized. A scanner or camera on or in the system reads the visual indicia, and a controller in communication with the scanner or camera is operative to reduce the functionality of the system if the visual indicia is incomplete or not present. In accordance with the embodiment, the system may not operate if the visual indicia is incomplete or not present.

The visual indicia may include a trademark, logo, or other information proprietary to a source of origin. The system may be a piece of medical equipment, and the part may be a consumable. As examples, the system may be a medical insufflators, and the part may be an insufflation set. Alternatively, the system may be a medical IV pump, medical IV controller, medical ventilator tubing set, medical respirator set, medical EEG set, medical EKG set, medical smoke evacuator set, medical body warming device, medical anaesthesiology set, medical suction irrigation set, medical cautery pencil or set, medical, floor fluid management device, medical pressure monitor, medical esophageal kit, medical ureteral kit, or a medical surgical navigation system.

### BRIEF DESCRIPTION OF THE DRAWINGS

FIG. 1 is a block diagram that illustrates a system according to the invention;

FIG. 2 is a diagram illustrating one implementation of the invention;

FIG. 3 illustrates how a camera may be mounted on the system to read the legend before the part is installed;

FIG. 4 shows how a camera may form part of a hand-held scanner, or the camera may be mounted on a stand and communicate in a wired or wireless manner to the system;

FIG. 5 shows how a camera may read indicia 522 within a part, making copying more difficult; and

FIG. 6 depicts how a camera may be configured to read indicia on a wall or side surface which may be even more difficult to reproduce and which may not even be visible to the unaided eye.

### DETAILED DESCRIPTION OF THE INVENTION

In broad and general terms, this invention ensures that only genuine (or authorized) replacement or consumable parts are used with consumer, commercial and industrial instruments and devices. Genuine or authorized parts include visual indicia that is scanned, and the instrument or device does not operate, or does not provide all desired functionality, if the scanned indicia is not interpreted as acceptable. In the preferred embodiments, the scanned indicia includes a proprietary trademark, logo, design or wording that would cause a supplier of non-genuineor non-authorized replacement or consumable parts to violate the trademark, copyright or other intellectual property rights of the OEM.

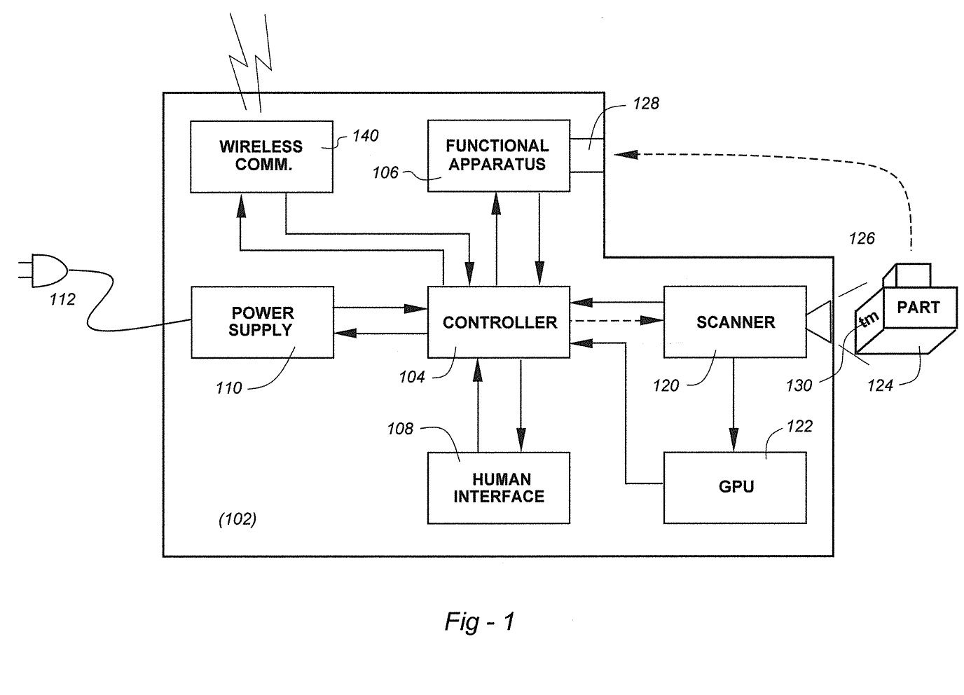

FIG. 1 is a block diagram that illustrates a system according to the invention. System 102 represents a generic device, equipment or instrument configured to accept a replacement or consumable part 124. System 102 may include a controller 104 that interfaces to general “functional apparatus” 106 and a human interface 108. Apparatus 106 represents subsystems responsible for performing the functions which give the equipment its name; for example, if system 102 is a medical instrument such as an insufflator, block 106 would represent the apparatus responsible for gas flow, heating, humidification, filtering, and other functions associated with medical insufflation.

Human interface 108 would represent and input devices such as switches, dials, etc., as well as any output devices such as meters, lights, display, audible devices, and so forth. The system 102 further includes a power supply 110. Although the supply 110 is shown connecting to a wall plug 112, power supply 110 may be self-contained and battery operated, for example.

In accordance with the invention, system 102 further includes a scanner 120 which, in the preferred embodiment, is a CCD camera in conjunction with OCR (optical character recognition) software. The scanner 122 may be interfaced to a graphics processing unit 122 which, in turns feeds controller 104, or the scanner may interface directly to the controller 104 as shown by the broken lines if the controller is capable of performing image-recognition functions.

Part 124 is placed in the field of view of scanner 120 to determine if part 124 is genuine and/or authorized. There may be different ways to expose part 124 to scanner 120 as discussed below. The genuine and/or authorized part includes visual indicia 130 which the scanner images and delivers the image data to GPU 122 or controller 104 for analysis. If the indicia 130 is deemed acceptable, the part 124 may be installed into the system via interface 126, 128. Alternatively, as described below, the part 124 may already be installed in the equipment or instrument when scanned.

If the part 124 in not deemed genuine and/or authorized, various functions may occur separately or together. For example, the entire piece of equipment may be disabled by controller 104 preventing power supply 110 to provide operational power. Some or all of the human interface may be disabled, such that some functions may be allowed whereas others may not, particularly those associated with the non-genuine part. As an option, an alarm may sound via human interface 108.

As a further option, the system may be provided with a wireless transmitter or transceiver 140 to alert a remote site that an attempt to use a replacement or consumable part is being used. Such communications may be in any form, including WiFi, satellite, etc. The remote site may perform various functions, such as analysis of the image gathered by the scanner 120, a look up of a computer-readable code scanned by scanner 120, etc. If communications block 140 is bi-directional, authorization to use the system 102 may come from the remote site. As one example of many, to slow down car theft, the visual indicia on a replacement windshield or other part might include a serial number which would then require the manufacture to send a satellite down load to the car to accept the part to ensure that the part was not stolen and that the part was an original OEM component. In this embodiment, a car constitutes system 102 and the windshield represents an auxiliary part 124.

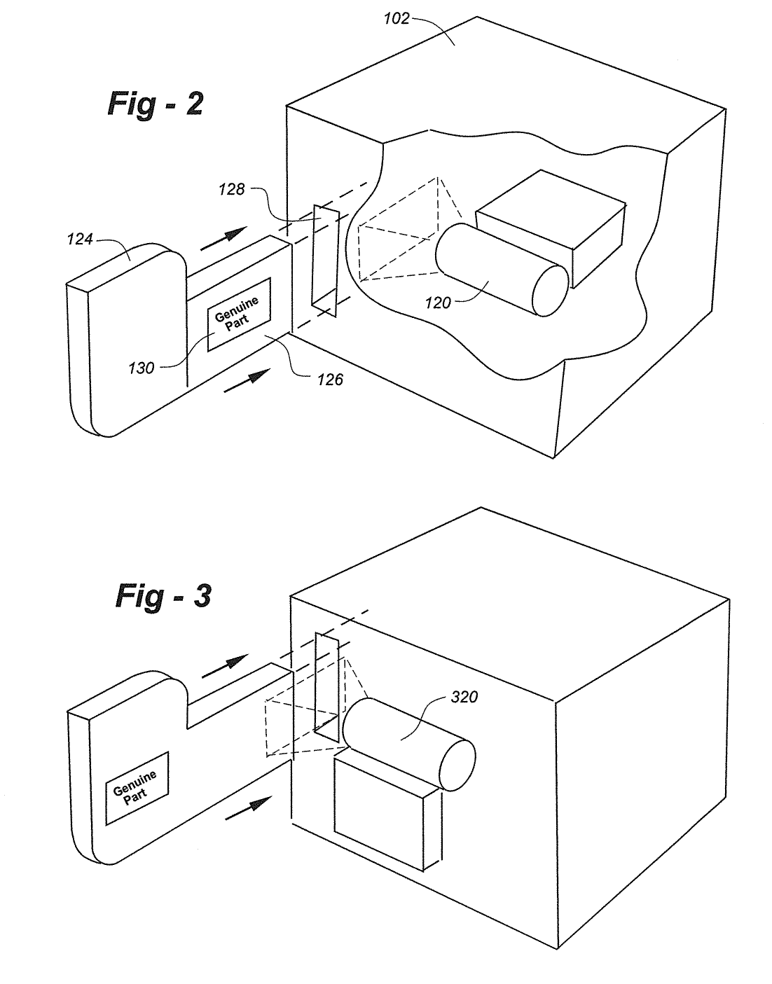

FIG. 2 is a diagram illustrating one implementation of the invention. In this drawing the system 102 includes scanner 120. Part 124 includes a portion 126 that fits into a receptacle 128 on the device 102. This drawing is generic in terms of the relative sizes and shapes of the components. System 102 can be any device, instrument or equipment requiring part 124 for operation, and part 124 may be a plug, cable, tubing set or any other replacement part, auxiliary part or consumable. For example, system 102 may be a medical device such as an insufflator, in which case part 124 may be a tubing set that plugs into the insufflator.

In the embodiment of FIG. 2, one side of the part 124 includes visual indicia 130, which is read by a scanner 120 built into the machine. The camera, in this case mounted in the instrument, reads the legend 130 and configures the machine to operate properly or not depending upon the content of the legend. The visual indicia 130 may include one or more words confirming that the installed part 124 is authorized. Examples might include the words “GENUINE,” “AUTHORIZED,” “LICENSED.” Such words may be used in conjunction with a company name such as “GENUINE FORD PART.”

In the preferred embodiments, the legend or indicia further includes some type of graphical symbol such as a company logo or proprietary design such that copying induces trademark and/or copyright violation or consumer fraud. One example of many is “GENUINE [symbol] PART.” The lettering could be inscribed or printed as long as it was clearly legible it could be on any shape of surface as long as the reader camera was properly placed. The scanning device 120 ensures that only the product(s) that were properly licensed or manufactured by the instrument manufacturer would run on the instrument 102.

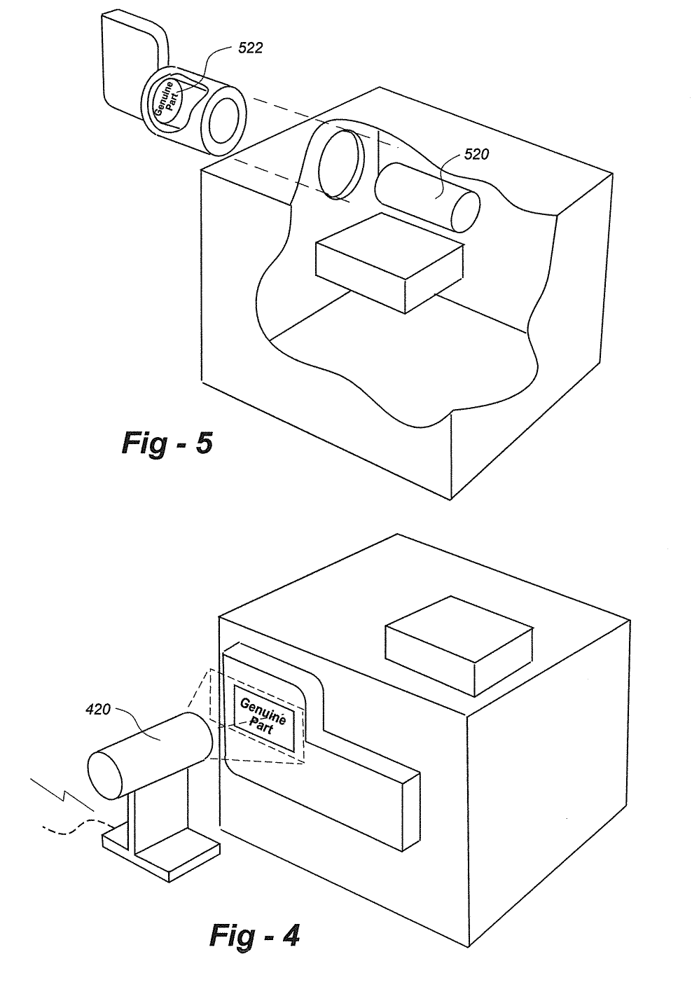

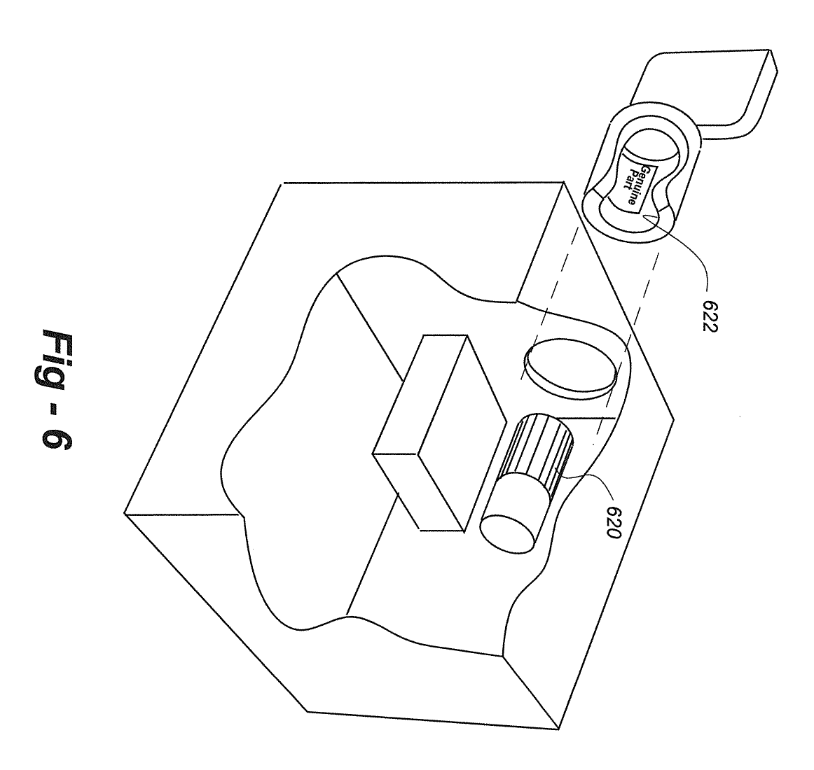

The camera/scanner need not be disposed in the system. As shown in FIG. 3 camera 320 may be mounted on the system to read the legend before the part is installed. A camera may form part of a hand-held scanner, or the camera 420 mounted on a stand 422 and communicate in a wired or wireless manner to the system (not shown in FIG. 4). As shown in FIG. 5, a camera 520 may read indicia 522 within a part, making copying more difficult. As shown in FIG. 6, the camera 620 may be configured to read indicia on a wall or side surface 622 which may be even more difficult to reproduce and which may not even be visible to the unaided eye.

1. Apparatus for ensuring that only genuine, licensed or authorized parts are used with a system, comprising:
visual indicia on or in the part confirming that the part is genuine, licensed or authorized;
a scanner or camera on or in the system to read the visual indicia; and
a controller in communication with the scanner or camera, the controller being operative to reduce the functionality of the system if the visual indicia is incomplete or not present.

2. The apparatus of claim 1, wherein the system does not operate if the visual indicia is incomplete or not present.

3. The apparatus of claim 1, wherein the visual indicia includes a trademark, logo, or other information proprietary to a source of origin.

4. The apparatus of claim 1, wherein the system is a piece of medical equipment and the part is a consumable.

5. The apparatus of claim 1, wherein the system is a medical insufflator and the part is an insufflation set.

6. The apparatus in claim 1, wherein the system is a medical IV pump.

7. The apparatus in claim 1, wherein the system is a medical IV controller.

8. The apparatus in claim 1, wherein the system is medical ventilator tubing set.

9. The apparatus in claim 1, wherein the system is a medical respirator set.

10. The apparatus in claim 1, wherein the system is a medical EEG set.

11. The apparatus in claim 1, wherein the system is a medical EKG set.

12. The apparatus in claim 1, wherein the system is a medical smoke evacuator set.

13. The apparatus in claim 1, wherein the system is a medical body warming device.

14. The apparatus in claim 1, wherein the system is a medical anaesthesiology set.

15. The apparatus in claim 1, wherein the system is a medical suction irrigation set.

16. The apparatus in claim 1, wherein the system is a medical cautery pencil, or set.

17. The apparatus in claim 1, wherein the system is a medical floor fluid management device.

18. The apparatus in claim 1, wherein the system is a medical pressure monitor.

19. The apparatus in claim 1, wherein the system is a medical esophageal kit.

20. The apparatus in claim 1, wherein the system is a medical ureteral kit.

21. The apparatus in claim 1, wherein the system is a medical surgical navigation systems.
